(19) United States
(12) Patent Application Publication
(10) Pub. No.: US 2021/0409647 A1
(43) Pub. Date: Dec. 30, 2021

(54) ROBOT SENSOR ARRANGEMENT SYSTEM

(71) Applicant: SYRIUS ROBOTICS CO., LTD., Shenzhen, Guangdong (CN)

(72) Inventor: Zhiqin YANG, Shenzhen, Guangdong (CN)

(21) Appl. No.: 17/294,429

(22) PCT Filed: Dec. 29, 2018
(86) PCT No.: PCT/CN2018/125146

§ 371 Date: May 17, 2021

(30) Foreign Application Priority Data
Nov. 19, 2018 (CN) 201821895318.0

(51) Int. Cl. H04N 7/18; G05D 1/02; G01S 17/931; G01S 15/931

(52) U.S. Cl. CPC H04N 7/18; G05D 1/0214; G05D 1/0272; G01S 2015/937; G05D 1/0246; G01S 17/931; G01S 15/931; G05D 1/027

(57) ABSTRACT

A robot sensor arrangement system. At least one sensor assembly is arranged on a robot body (20), wherein the sensor assembly comprises image sensors (1001, 1002) and a first inertial sensor (1007), and the positions of the image sensors (1001, 1002) relative to the first inertial sensor (1007) are fixed such that the image sensors and the first inertial sensor (1007) do not move as external physical conditions, such as vibration and temperature change. The included angle between the positions of the image sensors (1001, 1002) and a vertical axis is in a first angle range so as to ensure the robot can autonomously sense the surrounding environment to improve the capability of autonomous obstacle avoidance and the robustness of a robot system.

### CROSS-REFERENCE TO RELATED APPLICATIONS

The present disclosure claims priority to Chinese patent application No. 201821895318.0 filed to the China Patent Office on Nov. 19, 2018, the disclosure of which is hereby incorporated by reference in its entirety.

### TECHNICAL FIELD

The present disclosure relates to the field of robot sensing technology, and in particular relates to a robot sensor arrangement system.

### BACKGROUND

In the field of goods circulation, AGV (Auto Guided Vehicle) is often used to receive, transport and unload goods. Since the degree of intelligence of the AGV is lower than that of an intelligent mobile robot, the number of sensors arranged on the body of the AGV is relatively small. Generally, an image sensor used to identify the graphic code of a landmark and a magnetic sensor used to read information such as the magnetic strength of a magnetic stripe on the body of the AGV can realize an information sensing function.

Different from the AGV, the body of the robot is equipped with multiple types of sensors, including a laser sensor for collecting a distance, an image sensor for obtaining information about the surrounding environment, a depth image sensor for collecting three-dimensional structure, etc., as well as an ultrasonic ranging sensor for non-optical collection, etc. Said multiple types of sensors form a robot sensing system, allowing the robot to perceive the environment and perform tasks autonomously.

Although the existing robot sensing system can make the robot autonomously perceive the environment and perform tasks, the arrangement of its sensor assembly is not reasonable enough, so that the sensor assembly has many blind areas and low cooperation degree, which results in low accuracy of the fusion algorithm of the sensor assembly and low robustness of the sensing system. Among others, robustness comes from English Robustness, which refers to the capability of the system to avoid abnormalities and recover from abnormal conditions. Robustness embodied in the robot mainly refers to the robot cognitive capability to the surrounding environment. If the cognitive capability is high, the possibility of avoiding mistakes such as collision of the robot is high. Therefore, when arranging the sensor assembly for the robot, it is necessary to minimize the blind areas of the sensors to improve the robustness of the robot. In addition, there are multiple sensors in the sensor assembly that collect the same quantity. For example, the laser ranging sensor and the ultrasonic ranging sensor collect the distance from an obstacle around the robot to the robot itself at the same time. The low cooperation degree of the multiple sensors which collect the same physical quantity will reduce the accuracy of the multi-sensor fusion algorithm, which is not conducive to the robot's autonomous perception of the environment and execution of tasks.

In summary, the existing robot sensing system has a technical problem that the sensor assembly has many sensing blind areas and the cooperation degree is low.

### SUMMARY

In view of this, the purpose of the present disclosure is to provide a robot sensor arrangement system to solve the technical problem that the robot sensing system has many blind areas of a sensor assembly and low cooperation degree.

In order to solve the above technical problem, the embodiments of the present disclosure provide a robot sensor arrangement system. The robot sensor arrangement system includes a robot body on which at least one sensor assembly is arranged, and the sensor assembly includes an image sensor and a first inertial sensor of which the position relative to the image sensors is fixed.

The included angle between the positions of the image sensor and a vertical axis is in a first angle range.

In the robot sensor arrangement system provided by the embodiments of the present disclosure, at least one sensor assembly is arranged on the robot body, wherein the sensor assembly comprises an image sensor and a first inertial sensor, and the positions of the image sensor relative to the first inertial sensor are fixed such that the image sensors and the first inertial sensor do not move as external physical conditions such as vibration and temperature change. The included angle between the positions of the image sensor and the vertical axis is in the first angle range to ensure that the robot autonomously perceives the surrounding environment and improve the capability of autonomous obstacle avoidance and the robustness of the robot system.

### BRIEF DESCRIPTION OF THE DRAWINGS

FIG. 1 is a schematic structural diagram of a robot sensor arrangement system provided in an embodiment.

### DETAILED DESCRIPTION OF EMBODIMENTS

In order to make the objectives, technical solutions, and advantages of the embodiments of the present disclosure clearer, the following further describes the embodiments of the present disclosure in detail with reference to the accompanying drawings and embodiments. It should be understood that the specific embodiments described here are only used to explain the embodiments of the present disclosure, and are not used to limit the embodiments of the present disclosure. In the description of the embodiments of the present disclosure, it should be noted that the orientation or positional relationship indicated by the terms “center”, “upper”, “lower”, “left”, “right”, “vertical”, “horizontal”, “inner”, “outer” and so on is based on the orientation or positional relationship shown in the drawings, and is only for the convenience of describing the embodiments of the present disclosure and simplifying the description, and does not indicate or imply that the device or element must have a specific orientation, be constructed and operated in a specific orientation, and therefore cannot be understood as a limitation to the embodiments of the present disclosure.

In addition, in the description of the embodiments of the present disclosure, unless otherwise clearly specified and limited, the terms “installed”, “connected”, and “connection” should be interpreted broadly. For example, it may be a fixed or detachable connection, or integral connection; it may be a mechanical connection or electrical connection; it can be directly connected or indirectly connected through an intermediate medium, or it can be the internal connection of two components; and it can be a wireless connection or a wired connection. For those of ordinary skill in the art, the specific meanings of the above-mentioned terms in the embodiments of the present disclosure can be understood according to specific situations.

In addition, the technical features involved in the different implementations of the embodiments of the present disclosure described later can be combined with each other as long as they do not conflict with each other.

In the following, the embodiments of the present disclosure propose some preferred embodiments to teach those skilled in the art to implement.

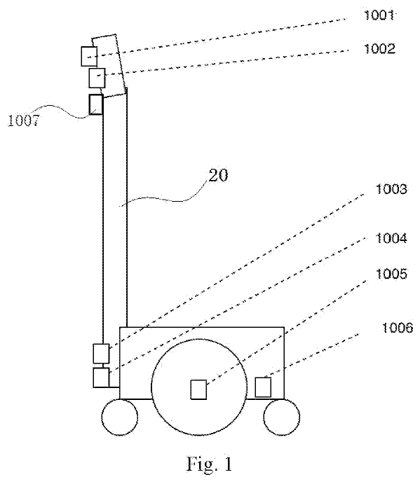

FIG. 1 is a schematic structural diagram of a robot sensor arrangement system provided by an embodiment, and shows a robot sensor arrangement system.

Referring to FIG. 1, a robot sensor arrangement system comprises a robot body 20 on which at least one sensor assembly is arranged, wherein the sensor assembly includes image sensors (1001, 1002) and a first inertial sensor 1007 of which the position relative to the image sensors (1001, 1002) is fixed.

The included angle between the positions of the image sensor (1001, 1002) and a vertical axis is in a first angle range, so as to ensure that the similar texture structures of a ground peripheral image are continuously collected.

In this embodiment, at least one sensor assembly is arranged on the robot body 20, wherein the sensor assembly includes the image sensors (1001, 1002) and the first inertial sensor 1007, and the positions of the image sensor (1001, 1002) relative to the first inertial sensor 1007 are fixed such that the image sensors (1001, 1002) and the first inertial sensor 1007 do not move as external physical conditions, such as vibration and temperature change. The included angle between the positions of the image sensor (1001, 1002) and the vertical axis is in the first angle range to ensure that the robot can autonomously perceive the surrounding environment to improve the capability of autonomous obstacle avoidance and the robustness of the robot system.

It should be noted that since the positions of the image sensor (1001, 1002) relative to the first inertial sensor 1007 are fixed and do not change as the external physical conditions such as the vibrations and temperature change, the information collected for the determined position can be controlled wherein each sensor is responsible for its own collection scope, and then the collected information is sent to the robot system to improve the fusion calculation and to form a stable division of labor and cooperation, so that the accuracy of the sensor fusion algorithm is improved and the robustness of the robot is improved, which is conducive to the robot's autonomous perception of the environment and execution of tasks.

It should also be noted that the included angle between the positions of the image sensor (1001, 1002) and the vertical axis is in the first angle range, so as to ensure that the similar texture structures of the ground peripheral image are continuously collected. Among others, the first angle range may be 5°-90°, preferably the angle value may be 10°

The video frames collected by the image sensors (1001, 1002) are analyzed to calculate the position and posture changes of the robot. In this process, there are certain requirements for the continuity of the video frames, and the continuity of the video frames comes from the continuous shooting of similar texture structures. Therefore, the included angle between the positions of the image sensor (1001, 1002) and the vertical axis is in the first angle range.

In a specific embodiment, the image sensors (1001, 1002) and the first inertial sensor 1007 are fixed on at least one piece of rigid material to realize the positions of the image sensor (1001,1002) relative to the first inertial sensor 1007 being fixed. Among others, the rigid material refers to a material that does not deform due to changes in the external physical conditions such as the vibration and temperature. It should be understood that the rigid material fixing method is only a preferred embodiment for realizing the positions of the image sensor (1001, 1002) relative to the first inertial sensor 1007 being fixed.

Further, the image sensors (1001, 1002) include a visible light image sensor 1002 and a depth image sensor 1001 of which the position relative to the visible light image sensor 1002 is fixed. The distances from the depth image sensor 1001 and the visible light image sensor 1002 to the ground are in the first distance value range, so that the field of view covers the collection scope. The first distance value range is 50 cm-160 cm. The preferred value of the first distance value range is 80 cm.

It should be noted that the distances from the depth image sensor 1001 and the visible light image sensor 1002 to the ground are in the first distance value range, so that the field of view covers the collection scope, and the field of view of the depth image sensor 1001 and the visible light image sensor 1002 covers a large area. Among others, the FOV (Field Of View) of the depth image sensor 1001 and the visible light image sensor 1002 is a cone in space. When the robot is working indoors, the larger the FOV, the larger the collection scope of the depth image sensor 1001 and the visible light image sensor 1002. When the distances from the depth image sensor 1001 and the visible light image sensor 1002 to the ground are not less than 80 cm, an ideal FOV can be achieved.

It should be noted that the working principle of the depth image sensor 1001 is: using a triangle TOF(Time Of Flight) formed by a binocular camera or a triangle formed by a visible light or non-visible light emitting device and a receiving device to collect for obstacles and form multiple images of distances from several points on the obstacles to the sensors.

In addition, the image data collected by the depth image sensor 1001 and the visible light image sensor 1002 is transmitted to the robot in the form of video frames. By analyzing the image data, the robot can locate its position in space and perform three-dimensional reconstruction of the surrounding environment; Meanwhile, machine vision perception such as face recognition, human body recognition, obstacle recognition, car lane or sign recognition can also be performed by analyzing images.

Specifically, the visible light image sensor 1002 and the depth image sensor 1001 are fixed on at least one piece of rigid material, and the position of the visible light image sensor 1002 relative to the depth image sensor 1001 is fixed. Among others, the rigid material refers to a material that does not deform due to changes in external physical conditions such as vibration and temperature. It should be understood that the rigid material fixing method is only a preferred embodiment for realizing the position of the visible light image sensor 1002 relative to the depth image sensor 1001 being fixed.

In an improved embodiment, the sensor assembly includes: an optical ranging sensor 1004, a second inertial sensor 1006, and a mechanical odometer 1005 of which the relative positions are fixed.

The mechanical odometer 1005 is fixed inside the robot wheel; the optical ranging sensor 1004 and the second inertial sensor 1006 are on the same plane or the vertical distance therebetween is in a second distance value range. Specifically, the second distance value range is 0-40 cm. The preferred value of the second distance value range is 20 cm.

It should be noted that the second inertial sensor 1006 is used to collect the inertia of the robot body 20, the optical ranging sensor 1004 is used to collect the distances between the robot body 20 and surrounding objects, and the mechanical odometer 1005 is used to collect the moving amount with regard to the rotation speed of the robot's wheels. Among others, the second inertial sensor 1006 can generally measure the physical quantities of which the three positive directions of acceleration, angle velocity, and magnetic field are orthogonal.

In addition, since the relative positions of the optical ranging sensor 1004, the second inertial sensor 1006, and the mechanical odometer 1005 are fixed and do not change as the external physical conditions change, the collected information for the determined position can be controlled, and each sensor is responsible for its own collection scope, and the collected information is then sent to the robot system for improved fusion calculations to form a stable division of labor and cooperation, so that the accuracy of the sensor fusion algorithm and the robustness of the robot are improved, which is conducive to the robot's autonomous perception of the environment and execution of tasks.

In addition, the mechanical odometer 1005 is generally fixed on the shaft of the wheel, and the rotation speed of the wheel is obtained through grating or electromagnetic induction. The rotation speed can be converted into the linear speed of the wheel through the radius of the wheel.

In addition, the optical ranging sensor 1004 can be a laser ranging sensor. The laser ranging sensor is equipped with a laser emitting and receiving device, and the distance from the obstacle to the sensor is calculated through a triangle relationship or TOF.

In addition, the number of rotations of the wheel per unit time can only be accurately measured when the wheel is in full contact and friction with the ground, so that the radius of the wheel can be used to calculate the corresponding arc length based on the above measurement value, that is, the moving distance of the robot relative to the ground per unit time, therefore, the mechanical odometer 1005 needs to be in contact with the ground.

The optical ranging sensor 1004, the second inertial sensor 1006, and the mechanical odometer 1005 are fixed on at least one piece of rigid material, and the relative positions of the optical ranging sensor 1004, the second inertial sensor 1006 and the mechanical odometer 1005 can be fixed. Among others, the rigid material refers to a material that does not deform due to changes in external physical conditions such as vibration and temperature. It should be understood that the rigid material fixing method is only a preferred embodiment for realizing the relative positions of the optical ranging sensor 1004, the second inertial sensor 1006, and the mechanical odometer 1005 being fixed.

The optical ranging sensor 1004 and the second inertial sensor 1006 are on the same plane or the vertical distance thereof is in the second distance value range. The purpose thereof lies in: generally, the optical ranging sensor 1004 can only measure the measurement points on the same plane, and only if the measured values of the second inertial sensor 1006 are also from this plane or from a plane parallel to this plane, the measured values of the two sensors can be cross-referenced.

In an improved embodiment, the sensor assembly includes an ultrasonic sensor 1003 of which the position relative to the optical ranging sensor 1004 is fixed. The collection direction of the ultrasonic sensor 1003 is the same as that of the optical ranging sensor 1004. The position of the ultrasonic sensor 1003 is based on the scanning plane of the optical ranging sensor 1004, and the distance from the scanning plane is in the third distance value range, so that the ultrasonic sensor 1003 compensates for the insufficient sensing of a transparent object by the optical ranging sensor 1004. Specifically, the third distance value range is 0-40 cm. The preferred value of the third distance value range is 20 cm.

It should be noted that the ultrasonic sensor 1003 uses sound waves to estimate the distance from the obstacle to the robot. Different from the optical sensor, the measurement value of this type of sensor is relatively rough, and the measurement scope is generally a cone in the space, which has the characteristics of large coverage and coarse accuracy. More importantly, this type of sensor can measure obstacles that optical sensors cannot sense, such as glass.

It should also be noted that the third distance value range may be any distance value that enables the ultrasonic sensor 1003 to compensate for the insufficient sensing of the transparent object by the optical ranging sensor 1004. Among others, the third distance value range may be 0-40 cm. Among others, 20 cm is preferred.

It should also be noted that since the ultrasonic sensor 1003 and the optical ranging sensor 1004 are responsible for their own collection scopes, the ultrasonic sensor 1003 collects information about transparent objects, and then sends the collected information to the robot system for improved fusion calculations and forming a stable division of labor and cooperation, so that the accuracy of the sensor fusion algorithm and the robustness of the robot are improved, which is conducive to the robot's autonomous perception of the environment and execution of tasks.

In an improved embodiment, the sensors in the sensor assembly are all mounted on the rigid structure and constitute a whole by at least one piece of the rigid structure.

It should be noted that since the sensors in the sensor assembly are all mounted on the rigid structure and constitute a whole by at least one piece of the rigid structure, the relative positions of the sensors in the sensor assembly are fixed and do not change as the external physical conditions, such as vibration and temperature change, so the collected information of the determined position can be controlled wherein each sensor is responsible for its own collection scope, and then the collected information is sent to the robot system for improved fusion calculations to form a stable division of labor and cooperation, so that the accuracy of the sensor fusion algorithm is improved and the robustness of the robot is improved, which is conducive to the robot's autonomous perception of the environment and execution of tasks.

The above descriptions are only the preferred embodiments of the present disclosure and are not intended to limit the present disclosure. Any modification, equivalent replacement and improvement made within the spirit and principle of the present disclosure shall be included in the protection scope of the present disclosure.

### INDUSTRIAL APPLICABILITY

In the robot sensor arrangement system provided by the present disclosure, at least one sensor assembly is arranged on the robot body, wherein the sensor assembly comprises an image sensor and a first inertial sensor and the positions of the image sensor relative to the first inertial sensor are fixed, so that the image sensors and the first inertial sensor do not move as the external physical conditions, such as vibration and temperature change. The included angle between the positions of the image sensor and the vertical axis is in the first angle range to ensure that the robot can autonomously perceive the surrounding environment to improve the capability of autonomous obstacle avoidance and the robustness of the robot system.

1. A robot sensor arrangement system, comprising a robot body on which at least one sensor assembly is arranged, wherein the sensor assembly comprises an image sensor and a first inertial sensor of which a position relative to the image sensors is fixed;
an included angle between the positions of the image sensor and a vertical axis is in a first angle range.

2. The robot sensor arrangement system according to claim 1, wherein the image sensor comprises a visible light image sensor and a depth image sensor of which the position relative to the visible light image sensor is fixed; the distances from the depth image sensor and the visible light image sensor to the ground are in a first distance value range, so that the field of view of the depth image sensor and the visible light image sensor covers a collection scope.

3. The robot sensor arrangement system according to claim 2, wherein the visible light image sensor and the first inertial sensor are fixed on at least one piece of rigid material.

4. The robot sensor arrangement system according to claim 1, wherein the first angle range is 5°-90°.

5. The robot sensor arrangement system according to claim 2, wherein the first distance value range is 50 cm-160 cm.

6. The robot sensor arrangement system according to claim 1, wherein the sensor assembly comprises: an optical ranging sensor, a second inertial sensor and a mechanical odometer of which the positions relative to each other are fixed;
the mechanical odometer is fixed inside a robot wheel, and the optical ranging sensor and the second inertial sensor are on the same plane or the vertical distance between the optical ranging sensor and the second inertial sensor is in a second distance value range.

7. The robot sensor arrangement system according to claim 6, wherein the second distance value range is 0-40 cm.

8. The robot sensor arrangement system according to claim 7, wherein the sensor assembly comprises an ultrasonic sensor of which the position relative to the optical ranging sensor is fixed, the collection direction of the ultrasonic sensor is the same as that of the optical ranging sensor, the position of the ultrasonic sensor is based on the scanning plane of the optical ranging sensor, and the distance from the ultrasonic sensor to the scanning plane is in a third distance value range, so that the ultrasonic sensor compensates for the optical ranging sensor in that the optical ranging sensor does not adequately sense transparent objects.

9. The robot sensor arrangement system according to claim 8, wherein the third distance value range is 0-40 cm.

10. The robot sensor arrangement system according to claim 9, wherein the sensors in the sensor assembly are all mounted on a rigid structure and constitute a whole by at least one piece of the rigid structure.

11. The robot sensor arrangement system according to claim 2, wherein the sensor assembly comprises: an optical ranging sensor, a second inertial sensor and a mechanical odometer of which the positions relative to each other are fixed;
the mechanical odometer is fixed inside a robot wheel, and the optical ranging sensor and the second inertial sensor are on the same plane or the vertical distance between the optical ranging sensor and the second inertial sensor is in a second distance value range.

12. The robot sensor arrangement system according to claim 3, wherein the sensor assembly comprises: an optical ranging sensor, a second inertial sensor and a mechanical odometer of which the positions relative to each other are fixed;
the mechanical odometer is fixed inside a robot wheel, and the optical ranging sensor and the second inertial sensor are on the same plane or the vertical distance between the optical ranging sensor and the second inertial sensor is in a second distance value range.

13. The robot sensor arrangement system according to claim 4, wherein the sensor assembly comprises: an optical ranging sensor, a second inertial sensor and a mechanical odometer of which the positions relative to each other are fixed;
the mechanical odometer is fixed inside a robot wheel, and the optical ranging sensor and the second inertial sensor are on the same plane or the vertical distance between the optical ranging sensor and the second inertial sensor is in a second distance value range.

14. The robot sensor arrangement system according to claim 5, wherein the sensor assembly comprises: an optical ranging sensor, a second inertial sensor and a mechanical odometer of which the positions relative to each other are fixed;
the mechanical odometer is fixed inside a robot wheel, and the optical ranging sensor and the second inertial sensor are on the same plane or the vertical distance between the optical ranging sensor and the second inertial sensor is in a second distance value range.
